(19) United States
(12) Patent Application Publication
(10) Pub. No.: US 2009/0051952 A1
(43) Pub. Date: Feb. 26, 2009

(54) IMAGE FORMING APPARATUS AND SCREEN GENERATING METHOD

(75) Inventors: SACHIKO ABE, Kanagawa (JP); Osamu Suzuki, Kanagawa (JP); Mitsuo Nakamura, Kanagawa (JP); Akira Yokoyama, Kanagawa (JP); Tomoko Miyoshi, Kanagawa (JP); Xiaojun Du, Kanagawa (JP)

Correspondence Address: IPUSA, P.L.L.C, 1054 31ST STREET, N.W., Suite 400, Washington, DC, 20007, US

(73) Assignee: RICOH COMPANY, LTD.

(21) Appl. No.: 12/186,591

(22) Filed: Aug. 6, 2008

(30) Foreign Application Priority Data
Aug. 21, 2007 (JP) 2007-215100
Jun. 24, 2008 (JP) 2008-165107

(51) Int. Cl. G06F 3/12

(52) U.S. Cl. 358/1.13

(57) ABSTRACT

An image forming apparatus includes a display unit configured to display a user interface screen inclusive of an operation screen, a display image information extracting unit configured to extract display image information from an information carrier medium having the display image information embedded therein, the display image information including an operation-purpose display image to be displayed on the operation screen, position information indicative of a position of the operation-purpose display image on the operation screen, and operation information indicative of an operation associated with the operation-purpose display image, and a user interface screen generating unit configured to generate a user interface screen based on the display image information extracted by the display image information extracting unit, the user interface screen having the operation-purpose display image that is placed at the position indicated by the position information and is associated with the operation indicated by the operation information.

### BACKGROUND OF THE INVENTION

1. Field of the Invention

The disclosures herein relate to image forming apparatuses having a customizable user interface.

2. Description of the Related Art

In recent years, advancement has been continuously made for image forming apparatuses such as multifunctional copiers, scanners, facsimile machines, and printers to diversify their functions. Against such a background, it is not always easy for users to make full use of these functions. While some of these functions may never be used by users, their presence may make it difficult to use the user interface.

In consideration of this, manufacturers are beginning to provide image forming apparatuses having a user-friendly interface for which users can select and arrange buttons that will frequently be used on the screen.

Japanese Patent Application No. 2006-133520 discloses a mechanism that makes it possible to customize an operation screen that is provided by default in an image forming apparatus. This mechanism uses screen design information retrieved from a memory unit of the image forming apparatus and user-entered information necessary for customization, thereby creating an operation screen.

Information regarding button size, position, description, and the like entered by a user is stored in memory. Such stored customized information and the screen design information retrieved from the memory unit of the image forming apparatus are used to generate and display a customized screen. With this arrangement, the disclosed mechanism makes it possible for the user to use the customized screen.

The technology described above is not so designed as to make it possible for a user to visualize how a user-interface screen appears after his/her customization. This prevents the user from fully utilizing the customization feature provided for a user interface screen. Further, the shapes and other features of buttons provided as default settings cannot be changed, and, thus, users cannot create their own shapes and features that may add a distinct appearance to the customized screen and may also be easier to operate. Moreover, a user interface screen that the user has customized by taking time can only be used in the apparatus on which the user worked on. This user interface screen cannot be used in any other apparatuses.

Accordingly, there is a need for an image forming apparatus that allows a user to easily create and customize a user interface screen in such a manner that the user can visualize how the screen will appear after customization.

### SUMMARY OF THE INVENTION

It is a general object of at least one embodiment of the present invention to provide an image forming apparatus and screen generating method that substantially eliminate one or more problems caused by the limitations and disadvantages of the related art.

In one embodiment, an image forming apparatus includes: a display unit configured to display a user interface screen inclusive of an operation screen; a display image information extracting unit configured to extract display image information from an information carrier medium having the display image information embedded therein, the display image information including an operation-purpose display image to be displayed on the operation screen, position information indicative of a position of the operation-purpose display image on the operation screen, and operation information indicative of an operation associated with the operation-purpose display image; and a user interface screen generating unit configured to generate a user interface screen based on the display image information extracted by the display image information extracting unit, the user interface screen having the operation-purpose display image that is placed at the position indicated by the position information and is associated with the operation indicated by the operation information.

In another embodiment, a method of generating a user interface screen includes: a display step of displaying a user interface screen inclusive of an operation screen; a display image information extracting step of extracting display image information from an information carrier medium having the display image information embedded therein, the display image information including an operation-purpose display image to be displayed on the operation screen, position information indicative of a position of the operation-purpose display image on the operation screen, and operation information indicative of an operation associated with the operation-purpose display image; and a user interface screen generating step of generating a user interface screen based on the display image information extracted by the display image information extracting step, the user interface screen having the operation-purpose display image that is placed at the position indicated by the position information and is associated with the operation indicated by the operation information.

According to at least one embodiment, an image forming apparatus allows a user to easily create and customize a user interface screen in such a manner that the user can visualize how the screen will appear after customization.

### BRIEF DESCRIPTION OF THE DRAWINGS

Other objects and further features of embodiments will be apparent from the following detailed description when read in conjunction with the accompanying drawings, in which:

FIG. 1 is a block diagram showing a basic hardware configuration of an image forming apparatus according to an embodiment of the present invention;

FIG. 2 is a drawing showing an example of the software configuration of the image forming apparatus;

FIG. 3 is a diagram showing a functional configuration of the image forming apparatus;

FIG. 4 is a flowchart showing steps performed by the image forming apparatus;

FIG. 5 is a flowchart showing transitions of a screen of the image forming apparatus;

FIG. 6 is a flowchart showing a process of registering a customized screen;

FIG. 7 is a flowchart showing transitions of a screen for registering a customized screen;

FIG. 8 is a drawing showing an example of a customize information description sheet;

FIG. 9 is a drawing showing an example of a PDF-format file;

FIG. 10 is a drawing showing an example of an XML-format file;

FIG. 11 is a drawing showing an example of an XUL-format file;

FIG. 12 is a drawing showing an example of an XAML-format file;

FIG. 13 is a drawing showing an example of use of a customize information description sheet;

FIG. 14 is a drawing showing an example of use of email;

FIG. 15 is a drawing showing an example of use of RSS feed; and

FIG. 16 is a drawing showing an example of use of a barcode.

### DESCRIPTION OF THE PREFERRED EMBODIMENTS

In the following, the best mode for carrying out the present invention will be described in connection with embodiments by referring to the accompanying drawings.

### [Outline and Configuration of Image Forming Apparatus]

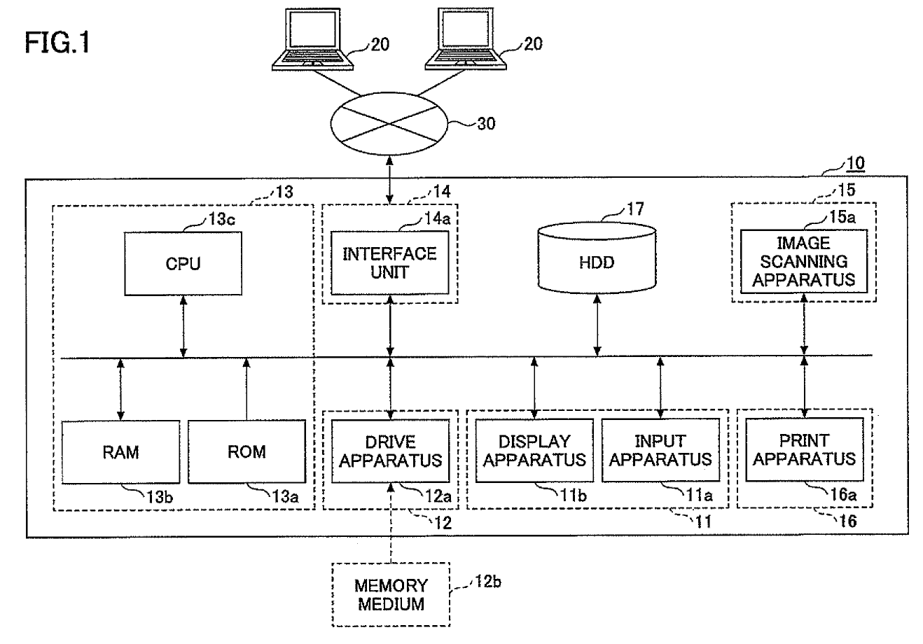

FIG. 1 is a block diagram showing a basic hardware configuration of an image forming apparatus 10 according to an embodiment of the present invention. The image forming apparatus 10 includes an operation panel 11, a memory-medium I/F (interface) 12, a controller 13, a data-communication I/F 14, a scanner 15, a plotter 16, and a HDD (hard disk drive) 17, which are connected to each other. In the following, a schematic description will be given.

The operation panel 11 includes an input apparatus 11a and a display apparatus 11b. The input apparatus 11a may be implemented as hardware keys or the like, and is used to enter various operation instructions to the image forming apparatus 10. The display apparatus 11b may be implemented as a display screen, and may display various types of information regarding image forming operations. The data-communication I/F 14 includes an interface unit 14a, which connects the image forming apparatus 10 to a data transmission line such as a network.

The controller 13 includes a ROM (Read Only Memory) 13a, a RAM (Random Access Memory) 13b, and a CPU (Central Processing Unit) 13c. The ROM 13a stores data and programs executed upon activation of the image forming apparatus 10. The ROM 13a further stores a program relating to creating a user interface screen according to the present embodiment. The RAM 13b serves as a temporal storage to temporarily store the programs and data retrieved from the ROM 13a and the HDD 17. The CPU 13c executes the programs temporarily stored in the RAM 13b. The controller 13 may receive print data via the data-communication I/F 14. In such a case, the controller 13 causes the CPU 13c to execute a program (i.e., PDL parser) capable of interpreting PDL (Page Description Language) after the program is loaded to the RAM 13b from the ROM 13a. The program interprets the print data to create a bitmap image.

The scanner 15 includes an image scanning apparatus 15a, which optically scans a document placed on the scan surface to generate scan image data. The scanner 15 further includes a barcode reader capable of scanning a barcode that is an identifier that represents numerical values and letters based on the arrangement of bars. The plotter 16 includes a print apparatus 16a, which prints a bitmap image on a recording sheet by use of an electrophotographic process, for example.

The HDD 17 stores various data such as received document data, scanned image data, log files, and data relating to the present embodiment (e.g., interface screen data, display image information) used by the image forming apparatus 10. The HDD 17 manages and controls these various data by use of a predetermined file system and DB (database) system.

The data stored in the HDD 17 also include electronic data recorded by use of an external apparatus. Such data may be supplied to the image forming apparatus 10 via a memory medium 12b such as a memory card, or may be uploaded via the data transmission line of the network. The memory medium 12b is mounted to a drive apparatus 12a of the memory-medium I/F 12. Data in the memory medium 12b is retrieved by the drive apparatus 12a for storage in the HDD 17.

The image forming apparatus 10 of the present embodiment has the hardware configuration as described above to provide multiple functions such as those of a copier, a printer, a facsimile (FAX) apparatus, a scanner, etc.

A PC 20 is a client terminal that is operated by a user to use a copy service, print service, facsimile service, and scan service as provided by the image forming apparatus 10 via a network 30. The PC 20 may be a conventional personal computer comprised of a CPU, a ROM, a RAM, an HDD, an input/output apparatus, a display apparatus, a communication apparatus, etc. The network 30 may include a wireless network and a wired network to connect between the image forming apparatus 10 and the PCs 20.

[Software]

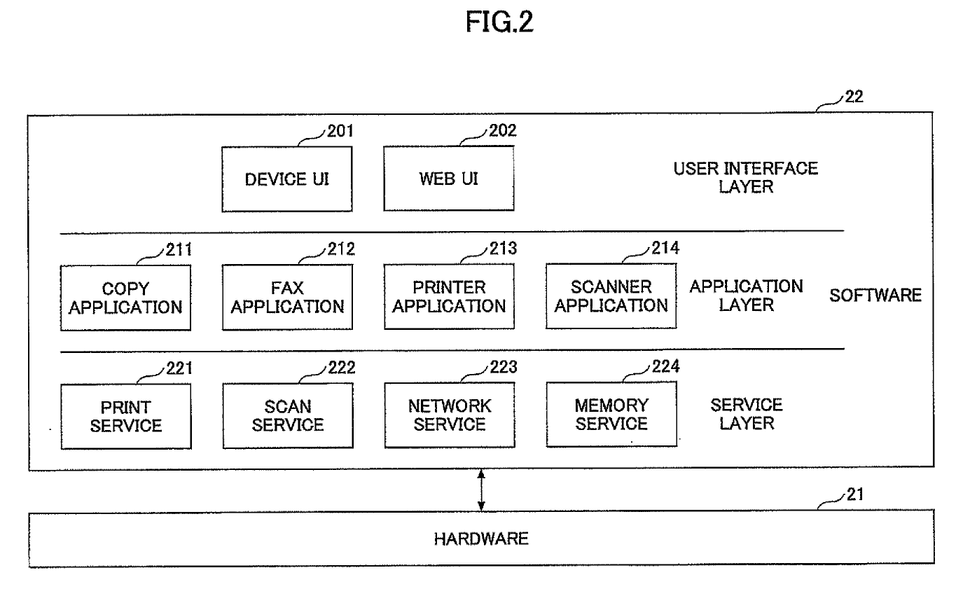

In the following, a description will be given of a software configuration of the image forming apparatus 10 in order to facilitate the understanding of the present embodiment. FIG. 2 is a drawing showing an example of the software configuration of the image forming apparatus 10. Software 22 of the image forming apparatus 10 includes a user interface layer for providing a user interface (UI) to users, an application layer for implementing various application functions, and a service layer for providing these functions by controlling hardware.

The user interface layer includes a device UI 201 for providing a user interface through the operation panel 11 of the apparatus, and also includes a Web UI 202 for providing a user interface that allows a user to manipulate the apparatus from the PC 20 through a Web browser.

The application layer includes a copy application 211 for providing a copy function, a fax application 212 for providing a fax function, a printer application 213 for providing a printer function, and a scanner application 214 for providing a scanner function.

The service layer provides the respective functions to the above-noted applications by controlling hardware 21. The service layer includes a print service 221 for controlling a plotter apparatus 16a, a scan service 222 for controlling the image scanning apparatus 15a, a network service 223 for controlling the interface unit 14a, and a memory service 224 for managing a work memory in the RAM 13b and the like.

When a user operates the operation panel 11 of the apparatus to copy a document, for example, the device UI 201 first receives an instruction from the user. The device UI 201 informs the copy application 211 of the specifics of the copy operation. The copy application 211 requests the scan service 222 to scan the document, and also requests the print service 221 to print the scanned document. Through these operations, the user obtains a hard-copy printout.

[Function of Image Forming Apparatus]

The image forming apparatus 10 of the present embodiment utilizes an image carrying medium such as a paper sheet or a data file to allow a user to easily create a user interface screen in such a manner that the user can easily visualize how the created screen appears. For example, the user illustrates (i.e., draws) a desired user interface screen on a paper sheet or the like. The user then operates the image forming apparatus 10 to scan the illustration on the paper sheet or the like. Based on the information scanned from the paper sheet or the like, the image forming apparatus 10 displays a user interface screen illustrated by the user on the screen of the display apparatus 11b (i.e., the operation panel 11).

For the purpose of facilitating the understanding of the present embodiment, a description will be given below of display image information used in the present embodiment. Display image information is the information carried by the information carrying medium such as a paper sheet or data file. Based on this display image information, the image forming apparatus 10 creates all or part of the user interface screen. The display image information includes an operation-purpose display image to be displayed on the operation screen such as the display apparatus 11b (i.e., the operation panel 11), position information indicating the position at which the operation-purpose display image is to be placed (arranged) on the operation screen, and operation information associated with the operation-purpose display image.

The operation-purpose display image to be displayed on the operation screen is a displayed image on which the user directly operates for the purpose of operating the apparatus on the user interface screen (i.e., the operation screen). An example of the operation-purpose display image is an image having a button shape that can be pushed or pressed.

The position information of the operation-purpose display image on the operation screen indicates the position at which the operation-purpose display image is placed on the operation screen displaying the user interface screen. The position information indicates a particular position such as left, right, top, and bottom in the frame of the operation screen.

The operation information associated with the operation-purpose display image defines an operation, instruction, jobs, or the like that is performed upon being pressed by the user when the operation-purpose display image has a button shape, for example. Such an operation may be an operation achieving a copy function, a printer function, a facsimile function, a scanner function, etc. When the operation-purpose display image is pressed, the associated operation will thus be performed.

As described above, the image forming apparatus 10 of the present embodiment acquires display image information from an information carrying medium such as a paper sheet or a data file, and displays a user interface screen intended by the user on the screen of the display apparatus 11b (i.e., the operation panel 11).

[Functional Configuration]

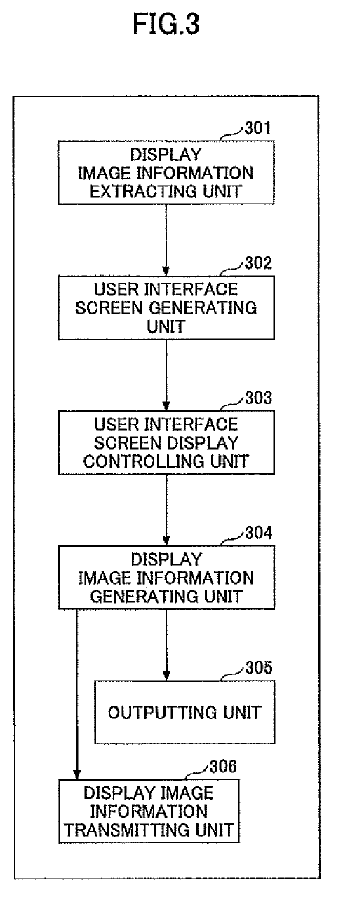

In the following, the functional configuration of the image forming apparatus 10 according to the present embodiment will be described by referring to FIG. 3. The image forming apparatus 10 includes a display image information extracting unit 301 for extracting display image information from an image carrying medium such as a paper sheet or data file, a user interface screen generating unit 302 for generating a user interface screen based on the display image information, a user interface screen display controlling unit 303 for displaying the generated user interface screen, a display image information generating unit 304 for generating display image information from the generated user interface screen, an outputting unit 305 for outputting the display image information via an information carrying medium, and a display image information transmitting unit 306 for transmitting the display image information to another image forming apparatus.

The display image information extracting unit 301 serves to extract (i.e., scan, read, retrieve, acquire) display image information from an information carrying medium. As previously described, the display image information includes an operation-purpose display image to be displayed on the operation screen, information about the position of the operation-purpose display image on the operation screen, and information about an operation associated with the operation-purpose display image. The display image information is important for the purpose of the present embodiment. The information carrying medium may be a paper medium such as a print sheet, which can be scanned by the image scanning apparatus 15a (i.e., scanner apparatus), or may be an electronic information medium such as a data file, which can be read by the drive apparatus 12a or loaded through the interface unit 14a.

The user interface screen generating unit 302 serves to generate a user interface screen to be displayed on the operation screen based on the display image information. The user interface screen (part or all thereof) is generated based on the display image information including an operation-purpose display image to be displayed on the operation screen, information about the position of the operation-purpose display image on the operation screen, and information about an operation associated with the operation-purpose display image. The operation-purpose display image may be an image of a rectangular button. The information about the position of the operation-purpose display image may indicate a center of the operation screen. The information about an operation associated with the operation-purpose display image may specify an instruction for performing color copying. In such a case, a user interface screen showing a rectangular button at the center of the operation screen is generated. A color copying operation will be performed upon pressing the button. It should be noted that the display image information extracted by the display image information extracting unit 301 is stored in the HDD 17 or the like. Display image information that is the data of the user interface screen generated by the user interface screen generating unit 302 may also be stored.

The user interface screen display controlling unit 303 controls the display apparatus 11b to display the user interface screen generated by the user interface screen generating unit 302 on the display apparatus 11b.

The display image information generating unit 304 serves to generate display image information from the user interface screen generated by the user interface screen generating unit 302. Details of this operation will be described later.

The user can further customize the generated user interface screen on the operation panel 11 to change or modify the shape of a button, the position of the button on the screen, the operation associated with the button, etc. Together with this modification, the display image information representing the user interface screen will also be modified, so that the modified display image information is stored in the HDD 17 or the like.

The outputting unit 305 outputs display image information by embedding it in an information carrying medium (e.g., a paper sheet, a barcode, a data file, or the like). If the information carrying medium is a paper sheet or barcode, the display image information is printed on a paper medium by the print apparatus 16a. If the information carrying medium is a data file or the like, the display image information is stored as data in the HDD 17.

The display image information transmitting unit 306 transmits display image information to another image forming apparatus via the network 30. This makes it possible for a user to use the user interface screen on another image forming apparatus. Display image information may be transmitted in its original form. Alternatively, the display image information may be converted into a format of an information carrying medium (i.e., data file) by the outputting unit 305 for transmission to another image forming apparatus.

[Processing Flow]

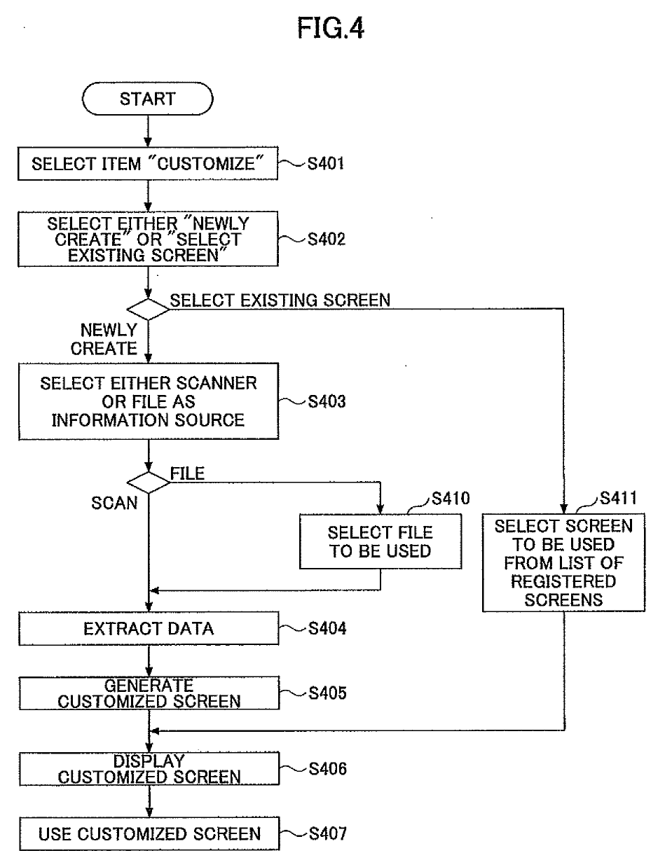

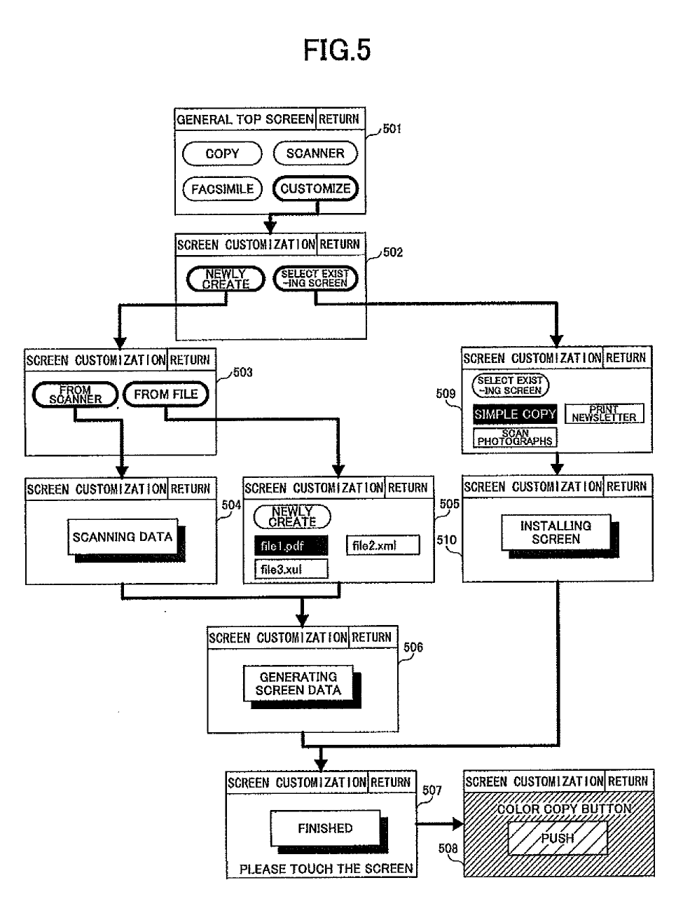

In the following, a description will be given of the process of generating a user interface screen by the image forming apparatus 10 of the present embodiment. For the purpose of this description, a flowchart of FIG. 4 showing process steps and a flowchart of FIG. 5 showing transitions of the screen will be used. FIG. 4 is a flowchart showing a procedure of generating a new operation screen. FIG. 5 is a flowchart showing transitions of the screen when the procedure of generating a new operation screen is performed.

The procedure of generating a new operation screen will be described first. On a general top screen 501 (see FIG. 5), a user selects the item “customize”, which triggers a transition to a customize-function top screen 502 (which corresponds to a transition from START to step S401 in FIG. 4). On the customize-function top screen 502, the user may select the item “newly create”, which triggers a transition to a selection screen 503 for selecting a method of creating a new screen (which transition corresponds to a transition from step S402 to step S403 in FIG. 4).

On the selection screen 503 for selecting a method of creating a new screen, the user may choose to acquire display image information by use of a scanner from a customize-information description sheet containing display image information. This triggers a transition to screen 504. The transition to the screen 504 informs the user that a process of scanning an image is underway (which corresponds to a transition from step S403 to step S404 in FIG. 4). Upon completion of the scan operation while the screen 504 is displayed, a process of generating a customized operation screen is started (which corresponds to step S405 in FIG. 4). In so doing, a transition to a screen 506 is made to inform the user that a process of generating an operation screen is underway. Upon completion of the screen generation, a transition to a screen 507 is made to inform the user of the completion. The user checks the message on the screen. The user then touches the screen to display a generated operation screen 508 that is actually usable for practical purposes (step S406 in FIG. 4). The user will hereinafter be able to use the displayed operation screen (step S407 in FIG. 4).

The screen 508 is an example of a generated operation screen. There is a button having the description “PUSH” at the center of the screen. The user may press the button “PUSH” to instruct the apparatus to perform color copying. In response, the image forming apparatus 10 performs color copying.

On the screen 503, the user may choose to create a new operation screen based on a file, which triggers a transition to a file selection screen 505 (which corresponds to a transition from step S403 to step S410 in FIG. 4). The user then selects a file that will be used to create a new operation screen. This file is a data file that contains display image information. Upon user selection of a file on the screen 505, a process of generating a new operation screen is performed (which corresponds to step S405 in FIG. 4). In so doing, a transition to the screen 505 is made to inform the user that a process of generating an operation screen is underway. Upon completion of screen generation, a transition to the screen 507 is made to inform the user of the completion. The user checks the message on the screen. The user then touches the screen to display a generated operation screen 508 that is actually usable for practical purposes (step S406 in FIG. 4). The user will be able to use the displayed operation screen for practical purposes (step S407 in FIG. 4).

When the user selects the item “existing screen” on the customize-function top screen 502, a transition to a selection screen 509 for selecting an operation screen from a list of existing screens is made. The user selects an existing screen on the screen 509 to install the selected existing screen. A transition to a screen 510 is then made to inform the user that a process of installing the selected existing screen is underway. Upon completion of screen installation, a transition to the screen 507 is made to inform the user of the completion. The user checks the message on the screen. The user then touches the screen to display a selected operation screen 508 that is actually usable for practical purposes (step S406 in FIG. 4). The user will hereinafter be able to use the displayed operation screen (step S407 in FIG. 4).

While the screen customization is performed, the message “screen customization” appears at the top of the screen, thereby informing the user that screen customization is underway. Further, a “return” button is provided at the top left corner of the screen. The user may press this button to stop the screen customization.

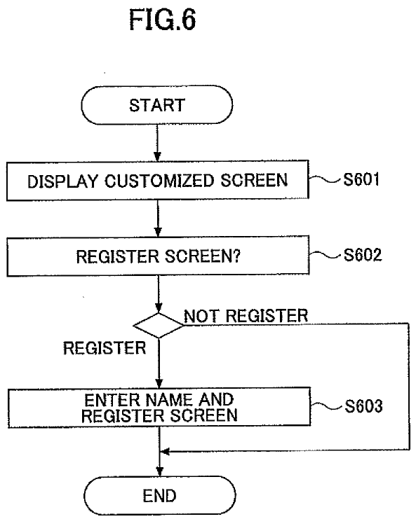

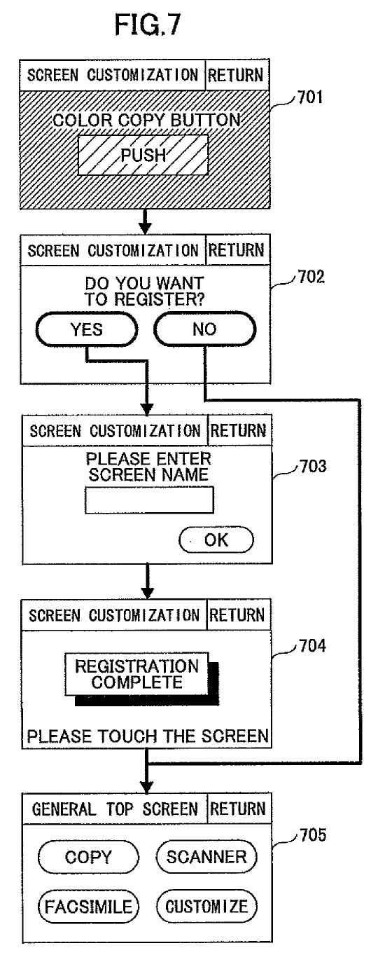

FIG. 6 is a flowchart showing an operation for registering a generated operation screen (i.e., steps following step S406 shown in FIG. 4). FIG. 7 is a flowchart showing transitions of the screen when the operation for registering a customized operation screen is performed (i.e., steps following 508 shown in FIG. 5).

Step S601 displays a generated operation screen (i.e., customized screen) generated according to the flowcharts shown in FIG. 4 and FIG. 5. This step corresponds to step S406 in FIG. 4. In order to register the generated operation screen (S602), the user stores the operation screen in the HDD 17 or the like by assigning a name to the screen (S603). Even when the power is turned off in the meantime, the user can later retrieve the registered screen to use this screen again. Provision may further be made such that the customized operation screen will be displayed by default without explicitly retrieving the screen when the apparatus is powered on.

When finishing using an operation screen 701, the list of registered operation screens is checked to see whether the generated operation screen is already registered. If a given registered operation screen has exactly the same display image information (i.e., an operation-purpose display image(s), position information, and operation information) as that of the generated operation screen, this registered operation screen is regarded as the same screen as the generated operation screen. As for operation-purpose display images, the data contents of the image files are compared with each other to determine whether the two images are the same. As for position information and operation information, the data contents of the character strings are compared with each other. If the generated operation screen is not yet registered, a transition to a screen 702 for inquiring of the need for registration is made (which corresponds to a transition from step S601 to step S602 in FIG. 6). The user may select the item “yes” to register the screen, which triggers a transition to a screen 703 for inquiring of a screen name (which corresponds to a transition from step S602 to step S603 in FIG. 6). The user enters a name for registration on the screen 703, and, then, a transition to a screen 704 is made to inform the user of a successful registration. Upon completion of registration, the apparatus returns to a general top screen 702 (which corresponds to a transition from step S603 to “END” in FIG. 6). When registration is not desired, the user selects the item “no” on the screen 702 (which corresponds to a transition from step S602 to “END” in FIG. 6).

[Customize Information Description Sheet]

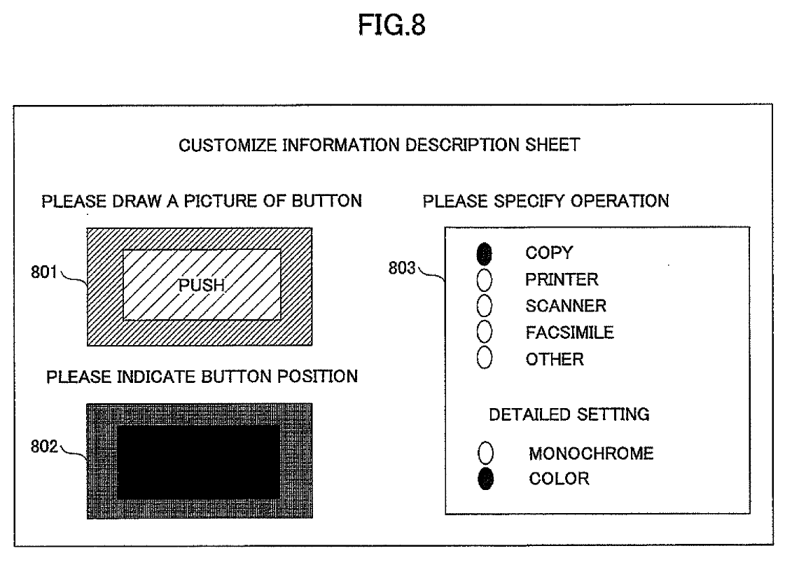

FIG. 8 is a drawing showing an example of a customize information description sheet. The customize information description sheet bears display image information for generating a user interface screen, and is scanned by a scanner or the like to enter the information into the image forming apparatus 10. When a sheet bearing display image information is scanned by a scanner or the like to enter the information into the image forming apparatus 10, it is preferable to use a predefined format for describing the information on the sheet. In consideration of this, a customize information description sheet is prepared as a standard format relating to the generation of a user interface screen. A user is expected to enter information necessary for the generation of a user interface screen according to this defined format. The image forming apparatus 10 knows rules regarding how to interpret information in this format with respect to positions (coordinates) on the format sheet. The rules indicate the position on the format sheet at which the information corresponding to an operation-purpose display image is to be found, which operation should be associated in response to a mark given at a given position, etc. These rules define a method of interpreting the format. With this arrangement, the image forming apparatus 10 (or display image information extracting unit 301) can reliably extract display image information from the customize information description sheet.

In the following, an example of items given on the customize information description sheet will be described. The customize information description sheet is formatted such that an operation-purpose display image to be displayed on an operation screen, information about the position of the operation-purpose display image on the operation screen, and information about an operation associated with the operation-purpose display image can properly be extracted from items 801, 802, and 803, respectively.

In the area of the item 801, a user illustrates (draws) a desired shape of an operation-purpose display image that may be a button, tab, or the like to be displayed on an operation screen. In the area of the item 802, the user specifies a desired position at which the operation-purpose display image is to be displayed on the operation screen. In so doing, the user may be required to place a mark corresponding to the image within a designated area of the item 802. In the area of the item 803, the user indicates an operation associated with the operation-purpose display image by checking a check box against the name of the operation. The user may check “copy” and “color” in the area of the item 803. In such a case, a “color copy” operation will be associated with the operation-purpose display image.

From the viewpoint of expandability, the item “other” is provided among the list of choices of operations. This item is provided to cope with a situation in which an operation desired to be used on the operation screen is not included in the list of selectable items. When the item “other” is selected, the operation that is desired to be used on the operation screen is optionally selected by use of a panel or hard key as an operation to be associated.

The customize information description sheet shown in FIG. 8 is only an example. A customize information description sheet may alternatively be formatted such that a plurality of operation-purpose display images can be generated (i.e., arranged). Selectable items shown in FIG. 8 are also only an example. Various other settings may also be made. For example, provision may be made to specify a “double-sided” copy mode, or to specify a print mode that prints a plurality of pages per sheet. The image forming apparatus 10 is provided with data indicative of the format of a customize information description sheet, so that a user can print as many blank customize information description sheets as necessary.

[Data File]

In the above description, the image forming apparatus 10 extracts display image information for generating a user interface screen by use of a customize information description sheet. Further, the image forming apparatus 10 can extract such information by use of a data file or the like rather than using a customize information description sheet as will be described in the following. When the image forming apparatus 10 is to acquire display image information in a data-file form, such information may be retrieved from the HDD 17 or may be retrieved via the network 30.

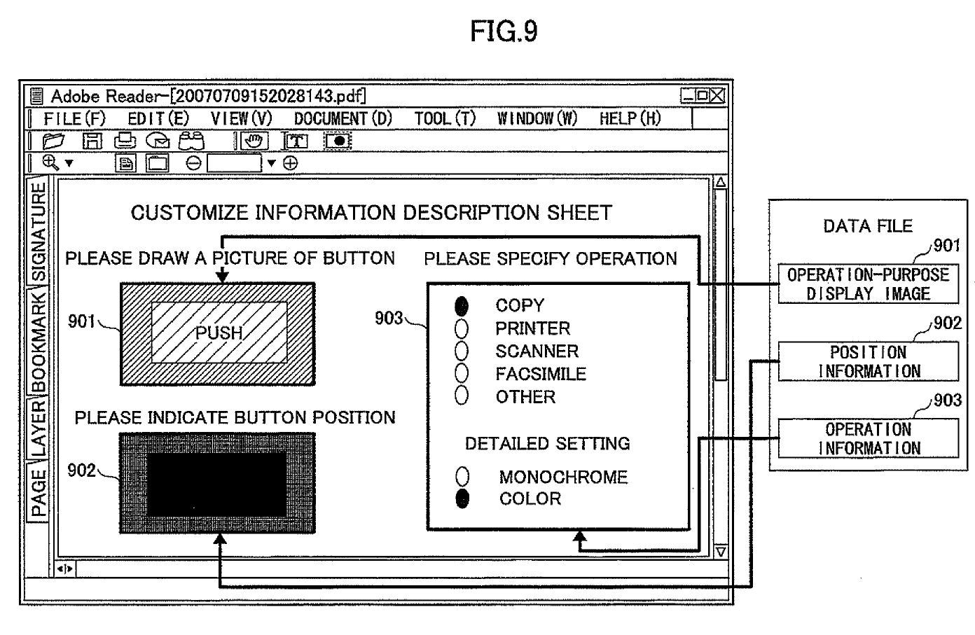

FIG. 9 through FIG. 12 show examples of data described in various data formats such as PDF (Portable Document Format), XML (Extensible Markup Language), XUL (XML User Interface Language), and XAML (Extensible Application Markup Language). A description will be given of examples in which display image information is obtained from a data file by use of a predetermined data format with reference to FIG. 9 through FIG. 12.

FIG. 9 is a drawing showing an example of data in PDF format. In a PDF file, display image information 901, 902, 903 similar to that used in the customize information description sheet is used. When data in PDF format is entered, the process previously described in connection with the scanning of information on the customize information description sheet will be performed in the same manner. Namely, the display image information extracting unit 301 extracts display image information such as an operation-purpose display image on the operation screen, position information, and operation information from the PDF file. Based on the extracted information, the user interface screen generating unit 302 generates a user interface screen.

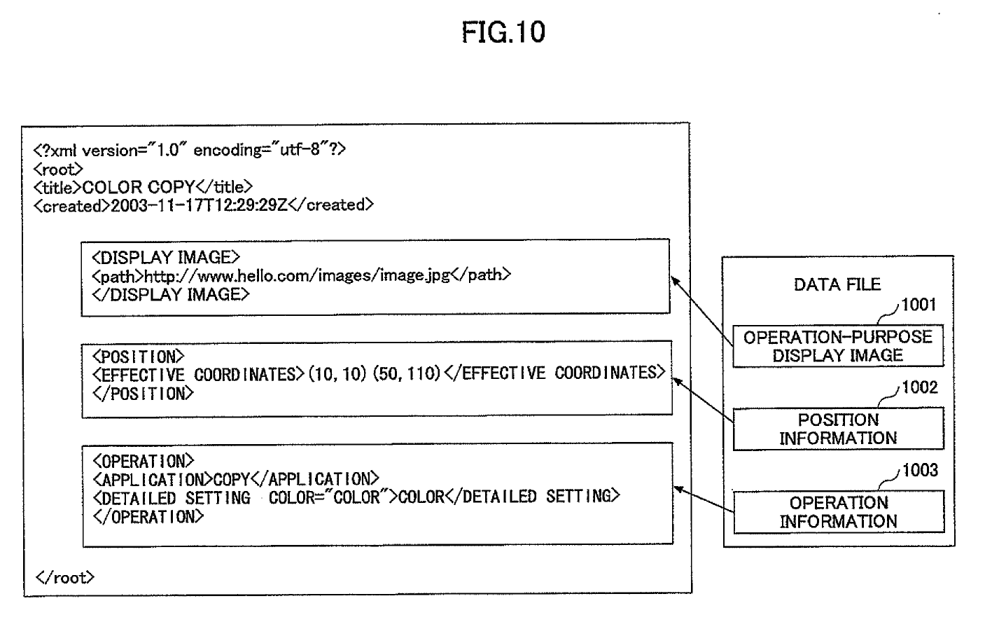

FIG. 10 is a drawing showing an example of data in XML format. In an XML-format file, text information is described by use of a markup language. An operation-purpose display image on the operation screen, position information, and operation information can thus be indicated by attaching respective tags. A display format may be determined in advance. When XML-format data is entered, an operation-purpose display image on the operation screen, position information, and operation information will be extracted from the data. Namely, the display image information extracting unit 301 extracts display image information such as an operation-purpose display image on the operation screen, position information, and operation information from the XML-format data. Based on the extracted information, the user interface screen generating unit 302 generates a user interface screen.

In the tags shown in FIG. 10, “image.jpg” is an operation-purpose display image 1001 and “(10, 10) (50, 110)” represents position information 1002. Further, color copying is specified as operation information 1003 to define an operation associated with the operation-purpose display image 1001.

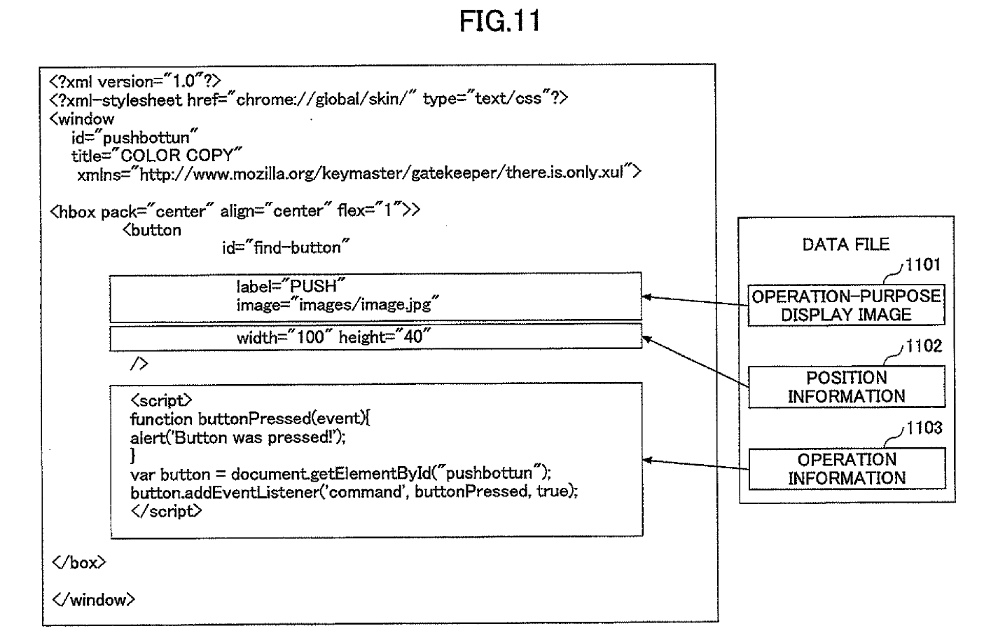

FIG. 11 is a drawing showing an example of data in XUL format. In an XUL-format file, data contents are described by use of an interface format provided by an OS (operating system). Content, skin, and locale are provided, which can be used to define operation information, an operation-purpose display imager and position information, respectively. When XUL-format data is entered locally or received via the network from another image forming apparatus or the like, the image forming apparatus 10 extracts an operation-purpose display image, position information, and operation information from the data. The extracted data is then used to generate a customized screen.

In the tags shown in FIG. 11, “image.jpg” is an operation-purpose display image 1101 on an operation terminal, and width=“100” and height=“40” represent a position 1102 on the operation terminal. Further, color copying is specified as operation information 1103 to define an operation associated with the operation-purpose display image 1101.

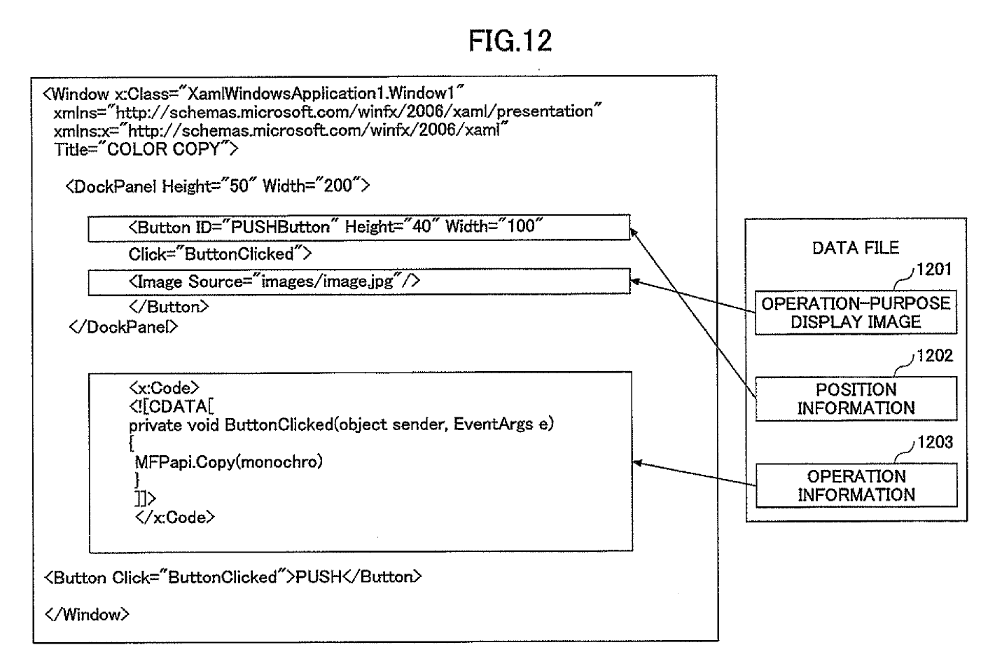

FIG. 12 is a drawing showing an example of data in XAML format. An XAML-format file allows a description in an interface format provided by application software. An operation-purpose display image on the operation screen, position information, and operation information can thus be described in this interface format for transmission to another image forming apparatus on which a user wishes to use a customized screen. When XAML-format data is entered locally or received via the network from another image forming apparatus or the like, the image forming apparatus 10 extracts an operation-purpose display image, position information, and operation information from the data. The extracted data is then used to generate a customized screen.

In the tags shown in FIG. 12, “image.jpg” is an operation-purpose display image 1201 on the operation screen, and width=“100” and height=“40” represent a position 1202 on the operation screen. Further, color copying is specified as operation information 1203 to define an operation associated with the operation-purpose display image 1201.

### [Transfer of Customized User Interface Screen to Another Apparatus]

In the following, transfer of a customized user interface screen to another image forming apparatus will be described. The user may wish to use a customized user interface screen at another image forming apparatus 10. In such a case, the user can use a “transfer” function to use the user interface screen at another image forming apparatus 10.

Referring to FIG. 3 again, the display image information generating unit 304 generates display image information from the user interface screen generated by the user interface screen display controlling unit 303. The display image information is then transferred to another image forming apparatus 10 via an image carrying medium that is output from the outputting unit 305 or transmitted from the display image information transmitting unit 306.

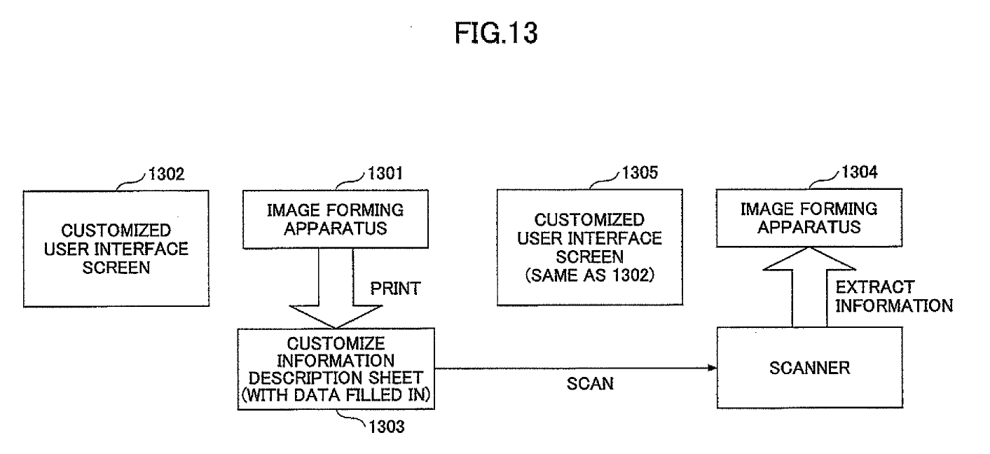

FIG. 13 is a drawing showing how a customize information description sheet generated based on a customized user interface screen is utilized at another image forming apparatus 10.

An image forming apparatus 1301 prints a customize information description sheet 1303 into which display image information based on a customized user interface screen 1302 is embedded. To be specific, the display image information is embedded (i.e., printed) on the customize information description sheet as shown in FIG. 8. Another image forming apparatus 1304 extracts (i.e., scans) the information printed on the customize information description sheet, so that the image forming apparatus 1304 can generate a customized user interface screen 1305 that is the same as the customized user interface screen 1302.

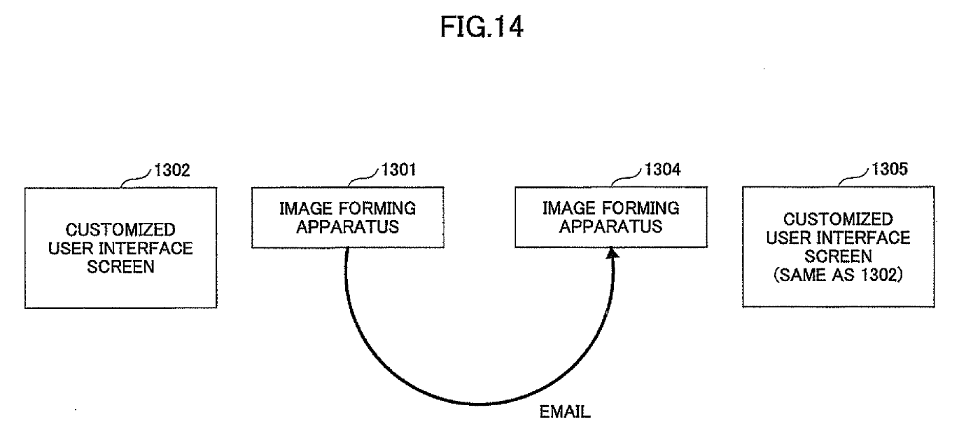

FIG. 14 is a drawing showing a case in which display image information regarding a customized user interface screen is transmitted via email. The image forming apparatus 1301 may transmit display image information regarding the customized user interface screen 1302 to another image forming apparatus 1304 by use of email. The image forming apparatus 1304 extracts the display image information as a data file to recreate the customized user interface screen 1305. This email may be transmitted with an attached data file in PDF format or the like as previously described. Alternatively, an email containing the display image information in its mail text portion with an indication of the employed format may be transmitted.

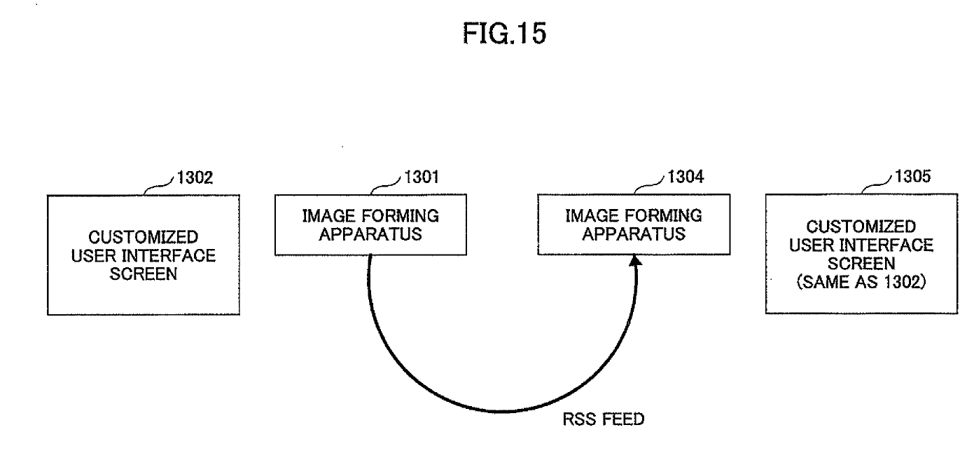

FIG. 15 is a drawing showing a case in which display image information regarding a customized user interface screen is transmitted via an RSS feed. The image forming apparatus 1301 may transmit display image information regarding the customized user interface screen 1302 to another image forming apparatus 1304 by use of the RSS feed. The image forming apparatus 1304 extracts the display image information as a data file to recreate the customized user interface screen 1305.

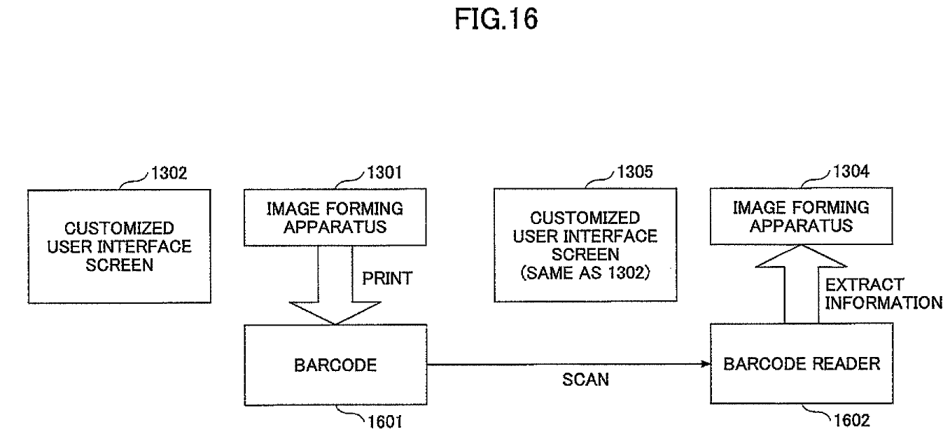

FIG. 16 is a drawing showing a case in which the customized user interface screen 1302 is reused at the image forming apparatus 1304 by utilizing a barcode. The image forming apparatus 1301 has the customized user interface screen 1302. The image forming apparatus 1301 prints on a paper medium a barcode made by converting display image information regarding the customized user interface screen 1302. A barcode 1601 printed on the paper medium is scanned by a barcode reader 1602 of the image forming apparatus 1304. The image forming apparatus 1304 extracts the display image information from the scanned information. In this manner, the image forming apparatus 1304 can present the customized user interface screen 1305 that is the same as the one used by the image forming apparatus 1301.

It should be noted that a portion generated through customization on the customized operation screen may be reedited. Such reediting is also possible in the case of a customized user interface screen received from another image forming apparatus. The original information prior to reediting is kept in memory as a backup. Thus, even when reediting is performed, the original customized operation screen can be recovered.

Further, the present invention is not limited to these embodiments, but various variations and modifications may be made without departing from the scope of the present invention.

The present application is based on Japanese priority applications No. 2007-215100 filed on Aug. 21, 2007, and No. 2008-165107 filed on Jun. 24, 2008, with the Japanese Patent Office, the entire contents of which are hereby incorporated by reference.

What is claimed is:

1. An image forming apparatus, comprising:
a display unit configured to display a user interface screen inclusive of an operation screen;
a display image information extracting unit configured to extract display image information from an information carrier medium having the display image information embedded therein, the display image information including an operation-purpose display image to be displayed on the operation screen, position information indicative of a position of the operation-purpose display image on the operation screen, and operation information indicative of an operation associated with the operation-purpose display image; and
a user interface screen generating unit configured to generate a user interface screen based on the display image information extracted by the display image information extracting unit, the user interface screen having the operation-purpose display image that is placed at the position indicated by the position information and is associated with the operation indicated by the operation information.

2. The image forming apparatus as claimed in claim 1, further comprising
a display image information generating unit configured to generate other display image information from the user interface screen; and
an outputting unit configured to output said other display image information by embedding said other display image information into an information carrying medium,
wherein the display image information extracting unit is configured to extract said other display image information from the information carrying medium into which said other display image information is embedded by the outputting unit.

3. The image forming apparatus as claimed in claim 2, wherein the image carrying medium is a paper medium, and the outputting unit is configured to print said other display image information on the paper medium.

4. The image forming apparatus as claimed in claim 3, wherein the outputting unit is configured to print said other display image information as a barcode on the paper medium.

5. The image forming apparatus as claimed in claim 2, further comprising an interface unit connected through a network to another image forming apparatus having another display image information extracting unit and another user interface screen generating unit, wherein the image carrying medium is a data file, and the outputting unit is configured to transmit the data file having said other display image information embedded therein to said another image forming apparatus via the network.

6. A method of generating a user interface screen, comprising:
a display step of displaying a user interface screen inclusive of an operation screen;
a display image information extracting step of extracting display image information from an information carrier medium having the display image information embedded therein, the display image information including an operation-purpose display image to be displayed on the operation screen, position information indicative of a position of the operation-purpose display image on the operation screen, and operation information indicative of an operation associated with the operation-purpose display image; and
a user interface screen generating step of generating a user interface screen based on the display image information extracted by the display image information extracting step, the user interface screen having the operation-purpose display image that is placed at the position indicated by the position information and is associated with the operation indicated by the operation information.
